(19) United States
(12) Patent Application Publication
(10) Pub. No.: US 2006/0109202 A1
(43) Pub. Date: May 25, 2006

(54) Multiple program and 3D display and 3D camera apparatus and process

(76) Inventor: Ray M. Alden, Raleigh, NC (US)

Correspondence Address: Ray M. Alden, 808 Lake Brandon Trail, Raleigh, NC, 27610, US

(21) Appl. No.: 10/994,556

(22) Filed: Nov. 22, 2004

(51) Int. Cl. G09G 3/00

(52) U.S. Cl. 345/32

(57) ABSTRACT

In a first preferred embodiment, this invention provides a low cost means for reliably providing auto-stereoscopic 3D high resolution images on a very large display. A vertical lenticular array is actuated in pixel wide increments to display full resolution auto-stereoscopic image from every pixel on the display such that many people watching a 3-D program see the program from tens of thousands of concurrent viewing positions. The identical vertical lenticular array also displays multiple video programs such that multiple people can each watch different programs on the display at the same time and full screen and full resolution (not picture in picture).

### CROSS-REFERENCE TO RELATED APPLICATIONS

This application is a continuation in part of the following patent applications by the present applicant; PCT application 04/16,563 filed May 27, 2004, U.S. application Ser. No. 10/884,423 filed Jul. 03, 2004, and U.S. application Ser. No. 10/903,443 filed Jul. 31, 2004.

### BACKGROUND FIELD OF INVENTION

Modem video display devices incorporate many technologies and methods for providing high quality video to users. Nearly every household in the United States has one or more video displays in the form of a television or a computer monitor. These devices generally use technologies such as Cathode Ray Tubes (CRT) tubes, FEDs, Liquid Crystal Displays (LCD), OLEDs, Plasma, Lasers, LCoS, Digital Micromirror Devices (DMD), front projection, rear projection, or direct view in one way or another. Large monitors offer the advantage of enabling many users to see the video monitor simultaneously as in a living room television application for example. Often video users do not want to view the same image streams as one another. Instead viewers would often like to see completely different programs or image streams at the same time. Alternately viewers would like to see the same program in 3D (three-dimensional) format. Moreover, people would like to enjoy high resolution images on their video monitors.

The prior art describes some attempts to enable multiple viewers to see different image streams concurrently on the same monitor. Many are drawn to wearing glasses that use polarization or light shutters to filter out the unwanted video stream while enabling the desired video stream to pass to the users' eyes. Much prior art that enables multiple users to watch different programs concurrently on the same display, full screen size and full resolution has been described by the present applicant in prior patent disclosure referenced below. The prior art also describes displays which use time sequenced spatial multiplexing as a means to enable multiple viewers to view auto stereoscopic 3D images on the same screen concurrently with the unaided eye. The prior art also describes a method for achieving high resolution images announced by Hewlett Packard where a lower resolution image generator such as a DLP produces a plurality of images representative of a single image frame and an element is actuated in physical distances on the order of a pixel in magnitude in synchronization with the image generator to produce alternate pixels on a diffuse surface. Moreover, no practicable display adequately incorporates multiple program viewing with auto-stereoscopic 3D to be viewed from the same Television pixels at the virtually the same time by multiple viewers together with the means to multiply the resolution of the image as does the present invention.

The present invention provides a significant step forward for video displays. The present invention describes display architectures that can be used with many display technologies together with specific implementations including a projector based pixel engine with an actuated reflective lenticular screen and a direct view based pixel engine with an actuated transmissive. The art described herein is suitable for enhancing the performance of many image generators including Cathode Ray Tubes (CRT) tubes, FEDs, Liquid Crystal Displays (LCD), OLEDs, Plasma, Lasers, LCoS, and Digital Micromirror Devices (DMD), and in front projection, rear projection, or direct view applications.

### BACKGROUND—DESCRIPTION OF PRIOR INVENTION

The prior art describes some attempts to enable multiple viewers to see different video streams concurrently on the same monitor. Many are generally drawn to wearing glasses that use polarization or light shutters to filter out the unwanted video stream while enabling the desired video stream to pass to the users' eyes. U.S. Pat. No. 6,188,442 Narayanaswami being one such patent wherein the users wear special glasses to see their respective video streams. U.S. Pat. No. 2,832,821 DuMont does provide a device that enables two viewers to see multiple polarized images from the same polarizing optic concurrently. DuMont however also requires that the viewers use separate polarizing screens as portable viewing aids similar to the glasses. DuMont further requires the expense of using two monitors concurrently. Japanese patent JP409105909A, Yamazaki et al describes a stationary lenticular array as the means to enable multiple program viewing, however the approach requires a corresponding diminution of resolution in direction relationship with the number of programs displayed concurrently. No known prior art provides a technique to enable multiple viewers to view separate video streams and watch auto stereoscopic 3D programs on a display without a diminution of resolution and which is also adapted to provide increased resolution over the capability of the image generator.

The so called “Cambridge Display” or “Travis Display” provides a well publicized means for using time sequential spatially multiplexed viewing zones as a method to enable multiple viewers to see auto-stereoscopic 3-D images on a display. This technique is described in U.S. Pat. No. 5,132,839 Travis 1992, U.S. Pat. No. 6,115,059 Son et al 2000, and U.S. Pat. No. 6,533,420 Eichenlaub 2003. The technique is also described in other documents including; “A time sequenced multi-projector auto-stereoscopic display”, Dodgson et al, Journal of the Society for Information Display 8(2), 2000, pp 169-176; “A 50 inch time-multiplexed auto-stereoscopic display” Proceedings SPIE Vol 3957, 24-26 Jan. 2000, San Jose Calif., Dodgson, N. A., et al.; Proceedings SPIE Vol 2653, Jan. 28-Feb. 2, 1996, San Jose, Calif., Moore,J. R., et al.; and can be viewed at http://www.cl.cam ac.uk/Research/Rainbow/projects/asd.html. This prior art typically relies on optics to first compress the entire image from a pixel generator such as a CRT tube, secondly an optical element such as a shutter operates as a moving aperture that selects which orientation of the entire compressed image can pass therethrough, thirdly, additional optics magnify the entire image, and fourthly the image is presented to a portion of viewer space. This process is repeated at a rate of approximately 60 hertz with the shutter mechanism operating in sync with the pixel generator to present different 3D views to different respective portions of viewer space. Two main disadvantages of this prior art are easily observable when viewing their prototypes. A first disadvantage is that a large distance on the order of feet is required between the first set of optics and the steering means, and between the steering means and the second set of optics. This disadvantage results in a display that is far too bulky for consumer markets or for any flat panel display embodiments. Secondly, looking at the display through large distances between optics creates a tunnel effect that tends to diminish the apparent viewable surface area of the resultant viewing screen.

According to Deep Light of Hollywood, Calif., the intellectual property comprising the “Cambridge display” is owned and being advanced by Deep Light. Also Physical Optics Corporation describes on their website that they are currently building a prototype of a time sequenced 3D display using liquid crystal beam steering at the pixel level similarly to that which has been described by the present applicant in the related applications referenced in this document.

Also Hewlett Packard has announced a “wobleation” process that physically moves a DLP image generator having a first resolution through a tiny position cycle in sync with driving it to produce every alternate pixel at a faster generation rate with the result being a higher second resolution image being projected on a diffuse surface. Increasing resolution using this methodology requires optics to manipulate the image at the sub pixel level or alternately, larger distances between pixel at the chip level, thus the actuation of the DLP chip approach to increasing resolution is not easily upgradeable without substantial cost to a user. Also, the method developed by HP requires a predefinition of what the maximum resolution of the display will be. Whereas the present invention discloses a means to change the resolution of the display on the fly as a function of the resolution of the image being displayed.

By contrast the present invention describes an actuate-able reflective lenticular or transmissive lenticular where the lenticular width is equal to the number of perspectives generated in the 3D application times the width of an individual pixel. The lenticular is then actuated perpendicular to the image the width of the lenticular in 1 pixel width increments. In the multiple program application, the lenticular is actuated perpendicular to the image a minimum distance of one lenticular width divided by the number of programs presented concurrently. Embodiments relying upon a reflective screen and a transmissive optic are described. The present invention also can increase the resolution of the image by producing images at higher speeds and actuating the lenticular less than one pixel width.

The present invention provides integration of multiple image perspectives and/or multiple programs in a novel manner and the presentation of the images to multiple viewers. The system provides a display for enabling multiple users to watch multiple 2-D or 3-D programs on the same display at the same time, full screen and full resolution.

Other relevant disclosures have been made by the present applicant including those cited at the beginning of this document which are incorporated herein by reference.

### BRIEF SUMMARY

The invention described herein represents a significant improvement for the users of displays. In a first reflective embodiment, a front projection screen with integral steering methodology and apparatus is provided to enable multiple users to concurrently watch completely different programs including auto-stereoscopic 3D programs with fill resolution in a large venue format which is highly reliable and cheap to produce. In a second transmissive embodiment, a rear projection or front view screen with integral steering methodology and apparatus is provided to enable multiple users to concurrently watch completely different programs including auto-stereoscopic 3D programs with full resolution in a desk top venue format which is highly reliable and cheap to produce. Also disclosed is a camera lens and filter apparatus and process for creating auto-stereoscopic 3D content in a format suitable for playing directly on the displays.

Thus the present invention offers a significant advancement in displays and auto-stereoscopic media.

Objects and Advantages

Accordingly, several objects and advantages of the present invention are apparent. It is an object of the present invention to provide an image display means which enables multiple viewers to experience completely different video streams simultaneously. This enables families to spend more time together while simultaneously independently experiencing different visual media or while working on different projects in the presence of one another or alternately to concurrently experience auto stereoscopic 3D media with their unaided eyes. Also, electrical energy can be saved by concentrating visible light energy from a display into narrower user space where a user is positioned. Likewise when multiple users use the same display instead of going into a different room, less electric lighting is required. Also, by enabling one display to operate as multiple displays, living space can be conserved which would otherwise be cluttered with a multitude of displays.

It is an advantage that the present invention doesn't require special eyewear, eyeglasses, goggles, or portable viewing devices as does the prior art.

It is an advantage of the present invention that the same monitor that presents multiple positionally segmented image streams also can provide true positionally segmented auto stereoscopic 3D images as well as stereoscopic images.

It is an advantage of the present invention that resolution is not sacrificed in order to achieve 3D images and neither is resolution sacrificed to present multiple concurrent positionally segmented image streams and neither is resolution sacrificed to present stereoscopic image streams.

It is an advantage of the present invention that the screen actuation utilized to steer pixels throughout user space is cheap to produce and very reliable.

It is an advantage of the present invention that the vertical lenticular screens utilized to steer pixels throughout user space are cheap to produce and very reliable.

It is a further object and advantage of the present invention to provide a camera that records 3D content in a format compatible for the 3D auto-stereoscopic display.

Further objects and advantages will become apparent from the enclosed figures and specifications.

### DRAWING FIGURES

FIG. 1 illustrates a front view of a reflective multiple program and 3D actuate-able lenticular screen of the present invention.

FIG. 2 depicts the components of a vertical lenticular and a fabrication process in a front view.

FIG. 3 depicts the actuation mechanism for an actuate-able lenticular screen.

FIG. 4a depicts a top view of the light ray trace of some pixels of the reflective lenticular screen in a first position.

FIG. 4b depicts a top view of the light ray trace of the pixels of FIG. 4a with the reflective lenticular screen actuated to a second position.

FIG. 5 depicts the flowchart of the 3D perspective integration and generation process of the present invention.

FIG. 6 depicts the flowchart of the multiple program image integration and generation process of the present invention.

FIG. 7 depicts a top view of overlapping pixels producible by the present invention for increasing horizontal parallax resolution.

FIG. 8 depicts a top view of a different mode of actuating a lenticular array.

FIG. 9 depicts a front view of a transmissive actuate-able lenticular array.

FIG. 10a is a top view of a 3D image recorder comprising an actuate-able vertical lenticular array in a first position.

FIG. 10b is a top view of a 3D image recorder comprising an actuate-able vertical lenticular array in a second position.

FIG. 11 depicts components comprising a 3D actuate-able vertical lenticular array image recorder with a horizontal lenticular.

### DETAILED DESCRIPTION OF THE INVENTION

### First Embodiment—Preferred

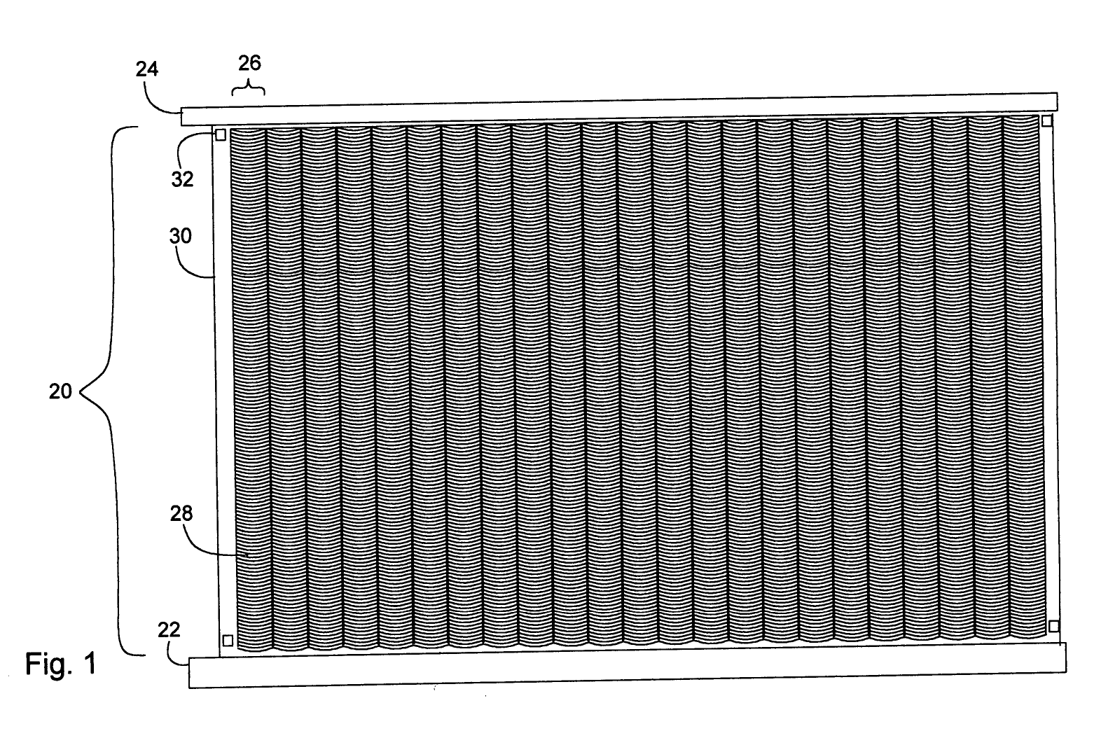

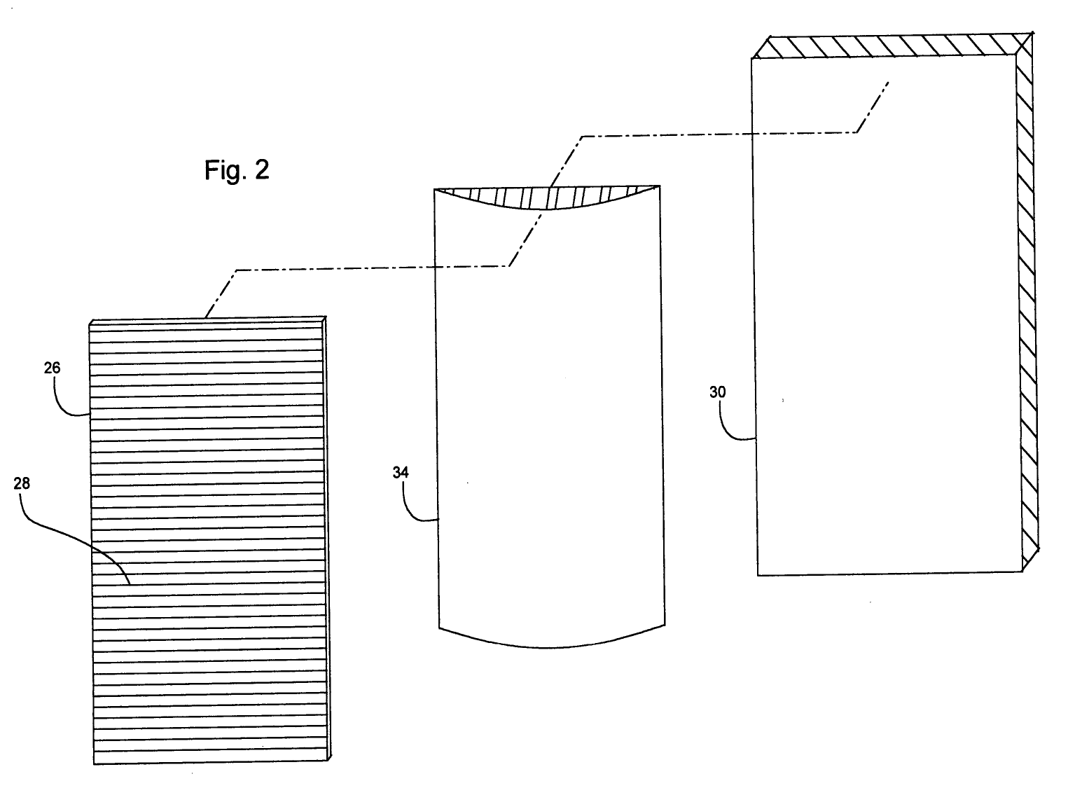

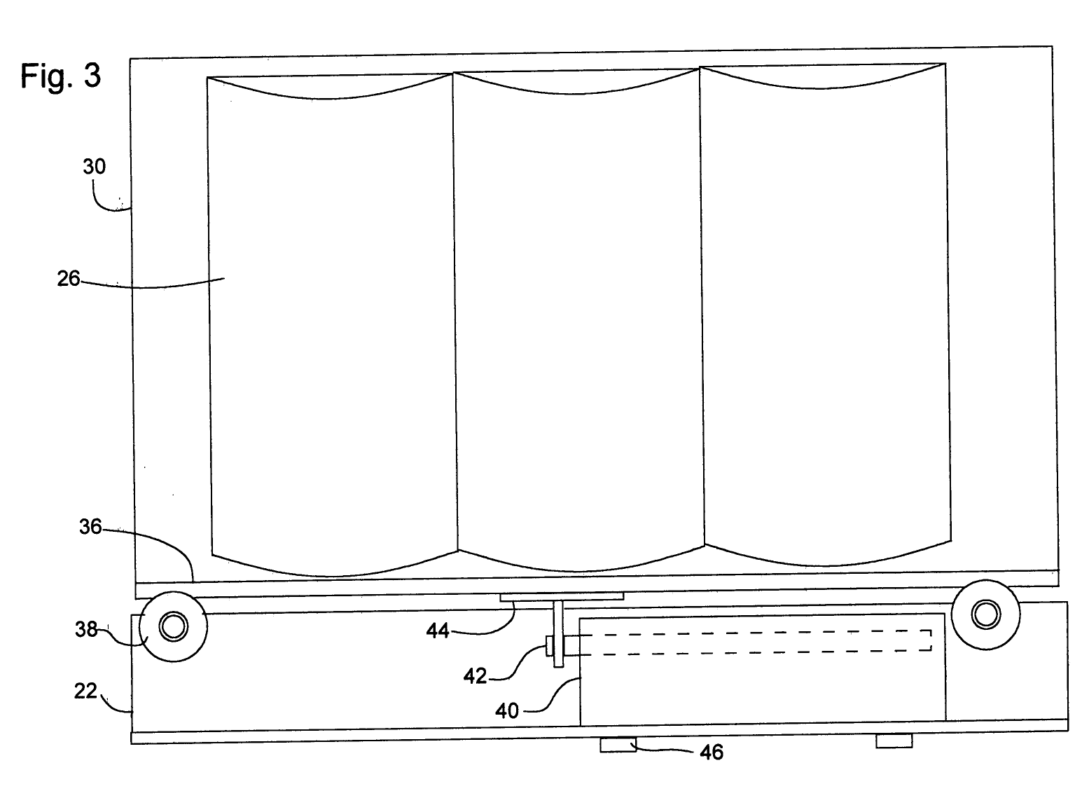

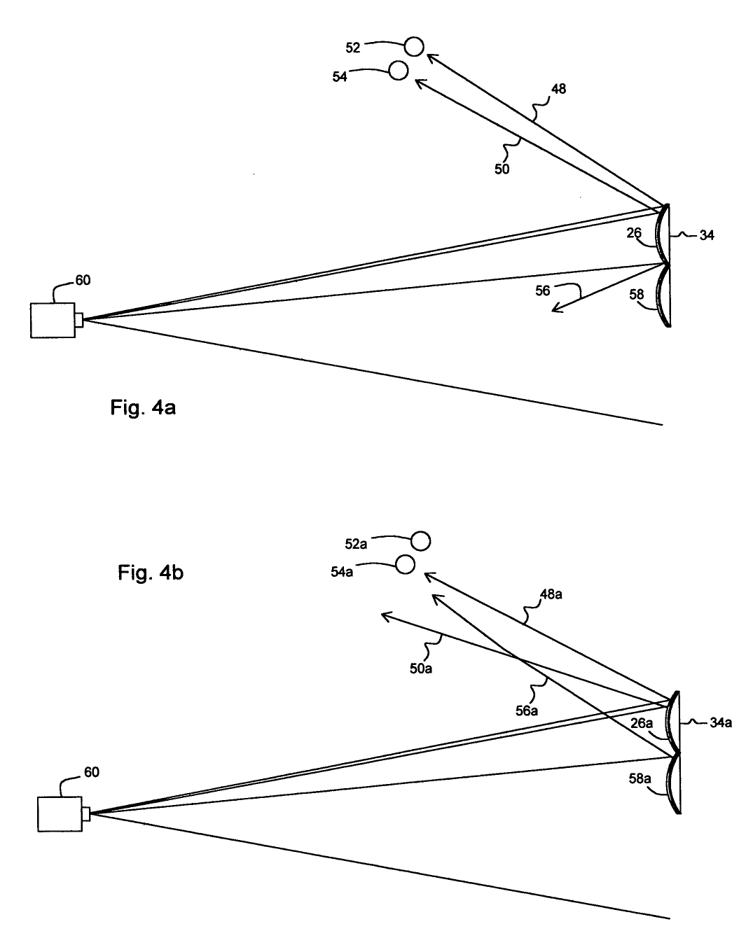

FIG. 1 illustrates a front view of a reflective multiple program and 3D actuate-able lenticular screen of the present invention. An actuate-able lenticular screen 20 comprises twenty three vertical lenticulars similar to a first vertical lenticular 26. The first vertical lenticular is comprised of a mirror quality reflective surface thinly deposited upon a plastic sheet fabricated and assembled according to FIG. 2. It is 4.5 inches wide, six feet tall and has a convex horizontal curvature of 25.5 degrees. When the first lenticular is fabricated, 960 smaller horizontal lenticulars are embossed thereon running across its width such as a first horizontal lenticular 28, the surface of the first lenticular be filled by the horizontal lenticulars. The curvature of the first horizontal lenticular is designed to spread an incident pixel vertically to fill the whole vertical range of a small horizontal width of user space. In a manor of speaking, the vertical lenticular shape provides non-diffuse reflection where each point of incident light is reflected in a narrow horizontal field of view and their corresponding horizontal lenticulars each provide directed diffuse reflection in an wide range of vertical field of view. The first horizontal lenticular abuts the horizontal lenticulars above it and below it such that the entire surface area of the vertical lenticular is cover by horizontal lenticulars. A discussion of curvatures required to efficiently cover the vertical range of user space is described by the present applicant in U.S. patent application Ser. No. 10/884,423 which is included herein by reference. A discussion of the horizontal reflection from the first vertical lenticular ensues under FIGS. 4a and 4b. The vertical lenticulars are glued with precision side by side butting against one another onto a rigid mounting board 30 which is fabricated from plastic. The rigid mounting board rests upon rollers residing within a bottom wall mounting assembly 22 as is described in FIG. 3 such that the rigid mounting board 30 can be actuated from right to left and back in precisely controlled increments as described herein such that each of the vertical lenticulars are reliably and controllably positioned to reflect light as described herein. A top mounting hardware assembly 24 is fastened to the wall similarly to 22 and similarly provides the support structure and rollers to ensure that the 30 can be actuated precisely, quickly, and reliably. A first emitter beacon 32 emits light that can be detected to ensure that the actuate-able lenticular screen is positioned precisely as required and in relation to a projection system later described.

FIG. 2 depicts the components of a lenticular and a fabrication process in a front view. The optical surface of the first vertical lenticular 26 is fabricated as a flat semi flexible sheet of horizontal lenticulars including the first horizontal lenticular 28 discussed above. This sheet is then glued to precisely fit onto a lenticular shaped rigid plastic form 34 such that the vertical lenticular conforms to the lenticular shape of the lenticular shaped rigid plastic form. It is at this stage of fabrication, that a thin mirrored reflective surface is applied to the surface of 26. The vertical lenticular shaped rigid plastic form is then precisely positioned and glued to the surface of the rigid mounting board such that the first vertical lenticular along with the other twenty two vertical lenticulars are precisely and permanently positioned adjoining one another with their horizontal lenticulars aligned with one another.

FIG. 3 depicts the actuation mechanism for an actuate-able lenticular screen. The rigid mounting board 30 carries the weight of all of the lenticulars including the first vertical lenticular 26. Affixed to and running the entire width of the bottom of the rigid mounting board is a steel foot 36 which maintains shape integrity over the course of many repeated actuations as it rides within a number of rollers including a first roller 38. The first roller is made out of steel to ensure shape integrity over many continued operational cycles and is shaped such that the steel foot controllably and reliably rides within the first roller. The bottom wall mounting assembly 22 provides support for each of the rollers including 38 which is connected by an axel which passes therethrough. The 22 and the 24 are manufactured from steel to ensure rigidity under the stress of weight while supporting the system. The bottom wall mounting assembly also provides support for an actuator 40 which is firmly bolted to the bottom wall mounting assembly using bolts including a first bolt 46. The actuator 40 comprises a threaded piston 42 which is rotatably in contact with a screen actuation bracket 44 which is firmly welded to the steel foot. During actuation cycles discussed herein, the actuator applies predetermined turns to the threaded piston to advance or retract it precisely and reliably as required which causes it in turn to apply leftward or rightward force to the screen actuation bracket 44 which causes the rigid mounting board 30 and its constituent lenticulars to be precisely positioned as later discussed.

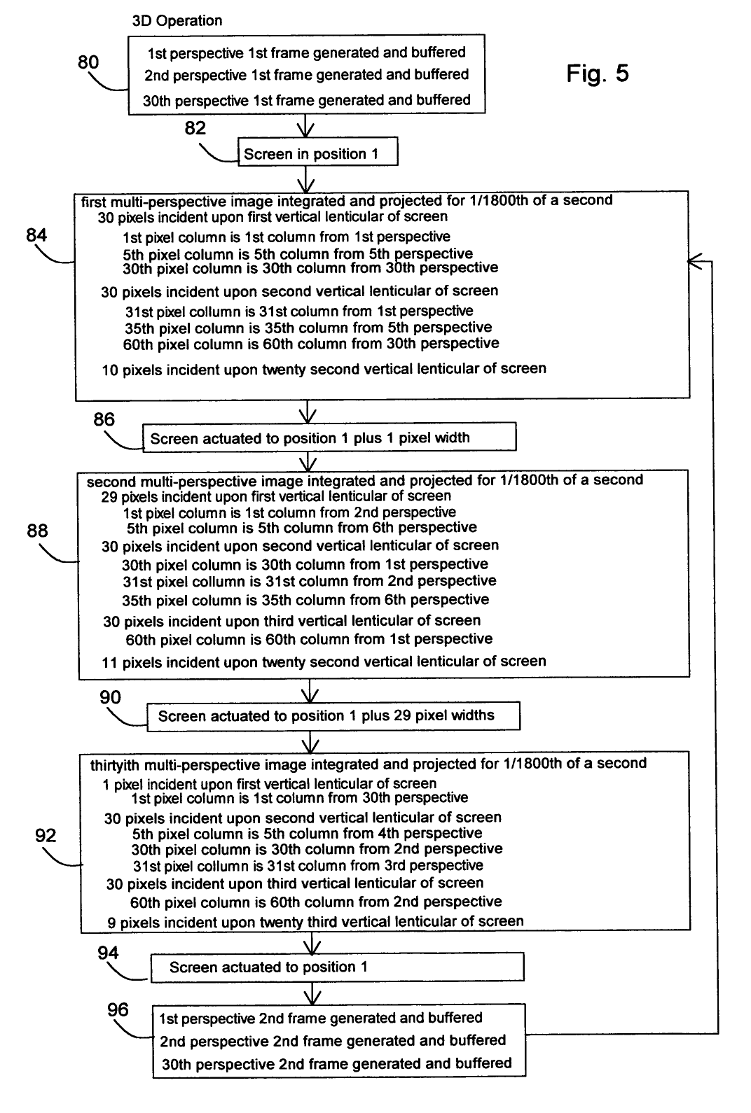

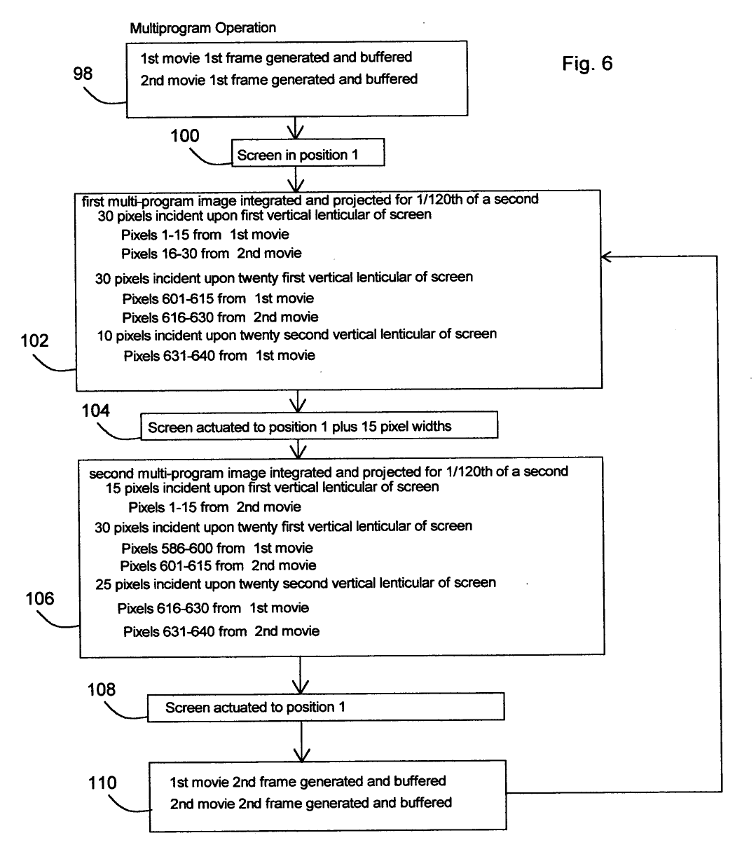

FIG. 4a depicts a top view of the light ray trace of some pixels reflected from the reflective lenticular screen in a first position. A three chip DLP based projector 60 incorporating a final lens of common configuration so as to produce a projected image shape comprising convergent pixels upon a projection screen located ten feet away. LightSpace Technologies is a supplier of three chip DLP pixel engine that operates at requisite speeds and when fitted with projection optics can project the image as described as do other companies. The three chip DLP based projector 60 produces a projected image onto the surface of the lenticular screen. In the 3D application, the image comprises a blend of perspectives as described in FIG. 5 and in the multiple program application the image comprises a blend of multiple programs according to FIG. 6. The optics of the three chip DLP based projector 60 cause a first pixel 48 to be incident upon the first vertical lenticular 26 with a convergent angle of 0.7 degrees which is reflected from a 0.85 degree curvature portion of the first vertical lenticular 26 which has a total curvature of 25.5 degrees which translates to a 0.85 degree curvature at the pixel level for 30 incident pixels each 0.15 inches wide at incidence. The horizontal curvature of the first vertical lenticular causes the first pixel 48 to be reflected across a one degree horizontal field of view such that it can be observed by the left eye 52 of an observer. Additional pixels numbering 479 in a vertical column beneath the first pixel are similarly reflected, the horizontal lenticulars spreading each of the pixels vertical so as to be observable by the 52. Horizontal lenticulars, two per pixel, cause each of the reflected pixels to be spread vertically throughout the user space while each reflected pixel remains only one degree wide horizontally. Similarly, a fifth pixel 50 is incident upon a different portion of the first vertical lenticular 26 with a convergent angle of 0.7 degrees which is reflected from a 0.85 degree curvature portion of the first vertical lenticular 26 which has a total curvature of 25.5 degrees which translates to a 0.85 degree curvature at the pixel level for 30 incident pixels each 0.15 inches wide at incidence. The horizontal curvature of the first vertical lenticular causes the fifth pixel 50 to be reflected across a one degree horizontal field of view such that it can be observed by the right eye 54 of an observer. As will be described in FIG. 5 the first pixel and the fifth pixel are each from one of thirty different perspectives of the same image rotated by increments of one degree off axis such that if one pixel is from the first perspective, the next pixel is from the second perspective and the one after that is from the third perspective so that a single pixel from each perspective is incident upon each of the vertical lenticulars at a given point in time and as the screen in actuated to thirty different positions, each pixel size spot on the screen will present one pixel from each of thirty different perspectives, whereby at each instance in time, the same perspective of the same image is present at every 30^{th} pixel in the image as is further described in FIG. 5. Alternately as described in FIG. 6, the first pixel and the fifth pixel may be from different images altogether or from the same perspective of the same image depending upon what video content is being presented. Thus the right eye and the left eye of the observer see different perspectives from pixels reflected from the 26 lenticular. At the instant in time represented in FIG. 4a, the right eye will not see any pixel light coming from the spot on the first vertical lenticular where the first pixel 48 was incident. However, as described in FIG. 4b, as the actuate-able lenticular screen 20 is actuated forward in one pixel wide (0.15 inch) increments, each of the observer's eyes will eventually see pixel light coming from each spot on the entire actuateable lenticular screen 20 representative of segments of each of the thirty different perspectives of the 3D image that were blended together and presented in cycles of thirty frames times sixty hertz or 1800 frames per second. A thirtieth pixel 56 is incident upon the first vertical lenticular 26 before going in a direction where it can not be observe red by the observer's right or left eyes.

FIG. 4b depicts a top view of the light ray trace of the pixels of FIG. 4a with the reflective lenticular screen actuated to a second position. The apparatus of FIG. 3, operating in synchronization with the three chip DLP based projector 60 cause the entire actuate-able lenticular screen 20 to advance to the left 0.15 inches and while the projector presents a different blended perspective image. As described in FIG. 5, the blending of the thirty perspectives is again performed such that each pixel produced in the image is from a perspective advanced by one degree such that when the alternate first pixel is incident upon the first lenticular in a first advanced position 26a, it represents a second perspective that is rotated one degree from the first pixel 48 of FIG. 4a and it is now incident upon a portion of the 26a corresponding to a reflective angle that will send the 48a one degree to the right compared to 48. It is note worthy that in effect, the first pixel of two images were both incident upon the same position of the screen but since the deflection angle at that point on the screen has changed due to the actuation of the lenticular array, the pixels of these two images are directed to different portions of user space. Thus the right eye 54a can now see a first pixel from an actuated screen 48a whereas in the first blended frame the 54a could not see any light from the first pixel column on the screen. Note also the thirtieth pixel from first actuated screen 56a is now incident upon the second vertical lenticular in first actuated position 58a whereas in the previous image frame, the thirtieth pixel was incident upon the first vertical lenticular 26. Thus the 56a thirtieth pixel from a screen actuated by one pixel width is sent in a direction that is rotated thirty degrees to the left compared to the 56 pixel that had been reflected from a non-actuated screen position. While the illustration does not properly illustrate it, in practice, the 48a and 56a trajectories are closer to parallel than is shown. In an iterative cycle, the screen is advanced in thirty 0.15 inch increments and then returned to its original position while in synchronization, the projector presents thirty images each comprised of a different blend of thirty perspectives such that each user's right eye and left eye individually see a blend of perspectives at sixty hertz and observes an auto-stereoscopic image stream. It should be noted that the ray trace of FIGS. 4a and 4b are technically inaccurate since the user is so far to the left that the left eye observing actuated lenticular 52a will only see the pixel described in FIG. 4a and no pixels in the subsequent 29 frames. Also the left and right eye are described as being five degrees apart in FIG. 4a yet a one degree rotation in FIG. 4b appears to bridge this five degree gap which is not possible but instead a subsequent five degree advancement of the screen will eventually rotate the first pixel column to be observed by the right eye. This is for illustrative purposes and otherwise the discussion herein is technically accurate and fully practicably. An actuated form 34a remains attached to the rigid back board and to the 26a lenticular. Thirty frames represents a single 3D frame representative of thirty perspective of the same image, each perspective from a one degree rotational increment beginning at negative fifteen degrees off axis and incrementing to positive fifteen degrees off axis. Software slices the thirty perspectives into thirty frames with intertwined perspectives corresponding with the shape and position of the lenticular screen. Each intertwined image containing a pixel column from the first perspective then a pixel column from the second perspective then a pixel column for the third perspective and so on. The screen must be precisely positioned relative to the projector such that the pixels line up vertically on the lenticulars within tight tolerances. Horizontal alignment need not be precise as long as the number of horizontal lenticulars exceeds the number of horizontal pixel rows. An alternate approach is to drop every thirty first pixel from the image so as to compensate for optical imperfections at the joining point between vertical lenticulars. Dropping of every thirty first pixel will not be problematic since the points at which the pixels are dropped will be changing at 1800 hertz and thus will not be observable to users. Also, in the software image generation environment, a decision can be made as to where the axis of image oration will be made within the image or within portions of the image so as to optimize perspectives for presentation in user space. Many 3D image generation software packages are capable of selecting not only the rotational increment angles but also the axis or axes of rotation.

FIG. 5 depicts the flowchart of the 3D perspective integration and generation process of the present invention. A perspective generation and buffering process 80 occurs in a digital processing environment and a buffer storage capacity remotely from the image projector. Once each of thirty first frame perspectives are processed, buffered, intertwined, and buffered as a single first frame representing a thirtieth of each of thirty perspectives, it is sent to the three chip DLP for presentation to the user space via and in synchronization with the actuation of the actuate-able lenticular screen. Each of thirty different perspectives of the first frame need to be generated and buffered for slicing and intertwining of perspectives before presentation by the projector. The actuate-able lenticular screen 20 is positioned in a first unactuated position 82. A first one thirtieth of a first frame 84 multi-perspective 3D image is processed, intertwined, buffered, sent to the projector, and presented to user space via the actuate-able lenticular screen for 1/1800 of a second. A total of 640 vertical pixel columns are presented to user space including thirty pixel columns incident upon each of twenty-one vertical lenticulars and ten pixels incident upon the twenty first lenticular. The thirty pixel columns incident upon the first vertical lenticular includes a first pixel column which during processing was taken from the first column of the first frame from the first perspective which is the perspective that is fifteen degrees off axis. When projected, this column is incident upon the portion of the first vertical lenticular that causes it to be reflected in a one degree wide vertical slice fifteen degrees off axis. The thirty pixel columns incident upon the first vertical lenticular include a second pixel column which during processing was taken from the second column of the first frame taken form the second perspective which is the perspective that is fourteen degrees off axis. This pixel column is projected to be incident upon the portion of the first lenticular so as to be reflected in a one degree wide vertical slice which is fourteen degrees off axis corresponding to the perspective from which it was derived. Similarly the portion of the first image incident upon the first vertical lenticular comprises a single pixel column from each of the thirty perspectives of the first frame which are incident upon the first vertical lenticular at the respective points so as to be directed at the proper off axis angle corresponding to the off axis angle from which they were respectively taken. Thus the first 1/30^{th} of the first frame is projected to he incident upon Twenty-two of the vertical lenticulars on the actuate-able lenticular screen which reflects light representative of 1/30^{th} of thirty perspectives of the first frame and which corporately cover a thirty degree field of view with light reflected from the screen at any given angle representative of a viewing perspective of the first frame from that same angle.

The actuate-able vertical lenticular screen this then actuated to a position one plus one pixel 86 or in other words advanced to the left by 0.15 inches. The thirty first frame perspectives that were generated and buffered in 80 are again resliced to generate a second thirtieth of a first frame representing a thirtieth of each of thirty perspectives, which is buffered and sent to the three chip DLP for presentation to the user space via and in synchronization with the actuate-able lenticular screen in second position. Each of thirty different perspectives of the first frame need to be sliced and intertwined before presentation to the projector. A second one thirtieth of a first frame 88 multi-perspective 3D image is processed, intertwined, buffered, sent to the projector, and presented to user space via the actuate-able lenticular screen for 1/1800 of a second. A total of 640 vertical pixel columns are presented to user space including thirty pixel columns incident upon each of twenty-one vertical lenticulars. Only twenty-nine thirty pixel columns are incident upon the first vertical lenticular since its left most edge has been actuated outside of the projected image width. Pixel columns incident upon the first vertical lenticular include a first pixel column which during processing was taken from the first column of the first frame from the second perspective which is the perspective that is fourteen degrees off axis. When projected, this column is incident upon the portion of the first vertical lenticular that causes it to be reflected in a one degree wide vertical slice fourteen degrees off axis. The twenty-nine pixel columns incident upon the first vertical lenticular include a second pixel column which during processing was taken from the second column of the first frame taken from the third perspective which is the perspective that is thirteen degrees off axis. This pixel column is projected to be incident upon the portion of the first lenticular so as to be reflected in a one degree wide vertical slice which is thirteen degrees off axis corresponding to the perspective from which it was derived. Similarly the portion of the first image incident upon the first vertical lenticular comprises a single pixel column from each of the twenty-nine perspectives of the first frame which are incident upon the first vertical lenticular at the respective points so as to be directed at the proper off axis angle corresponding to the off axis perspective angle from which they were respectively taken. Thus the second 1/30^{th} of the first frame is projected to de incident upon the actuate-able lenticular screen and reflects light representative of 1/30^{th} of thirty perspectives of the first frame and which corporately cover a thirty degree field of view with light reflected from the screen at any given angle representative of a viewing perspective of the first frame from that same angle. Of course the reader must wonder how come only 29 perspectives are described in this paragraph as being incident upon the first vertical lenticular. This is because the thirtieth pixel column is now incident upon the second vertical lenticular as described in FIG. 4b as pixel 56a. Thus the first thirty pixel columns of this image still represent the thirty different perspectives but are now corporately incident upon two vertical lenticulars. To ensure that all projected pixels are incident upon vertical lenticulars as the actuate-able lenticular screen is advanced to the left, it is necessary that the number of vertical lenticulars comprising the screen equals the number of vertical lenticulars upon which any portion of the image is incident at a given point in time (n) plus one lenticular or a total number of vertical lenticulars equal to n+1. Thus at any given point in time, the surface area comprising at least one whole vertical lenticular will have no light from the projector incident thereon. According to this formula, the system described herein comprises thirty three vertical lenticulars.

Thus the lenticular screen is actuated in 0.15 inch one pixel wide increments such that each pixel projected is over the course of 1/60^{th} of a second incident upon thirty different segments of either one or two vertical lenticulars and each pixel represents one of thirty perspectives for 1/1800^{th} of a second in cycles running sixty times per second. Thus two eyes seeing a single pixel position on the screen will see different perspectives seemingly concurrently but actually at slightly different points in time.

In this process, the screen is incrementally actuated 29 times and thirty intertwined images are presented that comprise a complete frame set representing a single frame of a thirty perspective 3D video. To complete this first thirty perspective frame, the screen is actuated to a left most position which equals position one plus twenty-nine pixels widths 90. While the screen is in this position, the projector presents the final segment of the first frame of the thirty perspective 3D image. A thirtieth multi-perspective intertwined sub-frame is presented 92. By this point, only one pixel column is incident upon the first vertical lenticular while nine pixel columns are incident upon the twenty-third vertical lenticular.

The screen is actuated to position one 94. The process of generating and presenting the second frame is initiated by generating the second frame of the movie from each of the thirty different 3D perspectives 96.

As described above, each pixel that is incident upon any vertical lenticular is spread vertically to vertically cover a complete section of user space by two horizontal lenticulars that comprise every pixel tall surface of every vertical lenticular. The minimum number of horizontal lenticulars on each vertical lenticular can be calculated as the number of pixel rows (p) plus 1. The larger the number above p, the less precise the image needs to fit onto the screen horizontally and this is why 2p horizontal lenticulars are recommended herein.

FIG. 6 depicts the flowchart of the multiple program image integration and generation process of the present invention patent application Ser. No. 10/884,423 includes a discussion of how to optimize the efficiency of presenting multiple programs that is included herein by reference. In an environment and process remote from the projector, first frames from two or more movies are stored 98 in a buffer. A vertical lenticular screen being in a first position 100. In a remote environment and process the first frames of each of the movies which are stored in the buffer are sliced and intertwined to create a first half of the first frames of the two movies which is stored in a buffer. A first half of the first frame of the first movie and a second half of the first frame of the second movie image. This intertwined first half of the first frame is buffered and sent to the projector 102. The projected first half of the first frame is incident upon each of the vertical lenticulars such that every first alternate 15 pixels is cut from the first movie and incident upon a leftward reflecting curvature of a lenticular while every second alternating 15 pixels are cut from the second movie and incident upon a rightward reflecting curvature of a lenticular. Thus light representing the first half of the first frame of the first movie is directed to the left part of the viewer space while light from the first half of the first frame of the second movie is directed to the right part of the viewer space. The lenticular screen is actuated fifteen pixels to the left 104. In the remote environment and process the first frames of each of the movies which are stored in the buffer are sliced and intertwined to create a second half of the first frames comprising a second half of the first frame of the first movie and a first half of the first frame of the second movie image. This intertwined second half of the first frame is buffered and sent to the projector 102. The projected second half of the first frame is incident upon each of the vertical lenticulars 106 such that every first alternate 15 pixels is cut from the second movie and incident upon a rightward reflecting curvature of a lenticular while every second alternating 15 pixels are cut from the first movie and incident upon a leftward reflecting curvature of a lenticular. Thus light representing the second half of the first frame of the first movie is directed to the left part of the viewer space while light from the first half of the first frame of the second movie is directed to the right part of the viewer space. The Lenticular screen is actuated back to the first position 108. The second frame of the first movie and second frame of the second movie are generated and buffered in an environment and process remote from the projector 110. In an iterative process each frame of the first movie is intertwined with a frame from the second movie and each frame is present in two installments by the projector in sync with the positioning of the vertical lenticular screen, reflected from the vertical lenticulars to a respective portion of user space such that a left side user sees the first movie and a right side user sees the second movie. Sound for respective movies is discussed in patent application Ser. No. 10/884,423 and incorporated herein by reference.

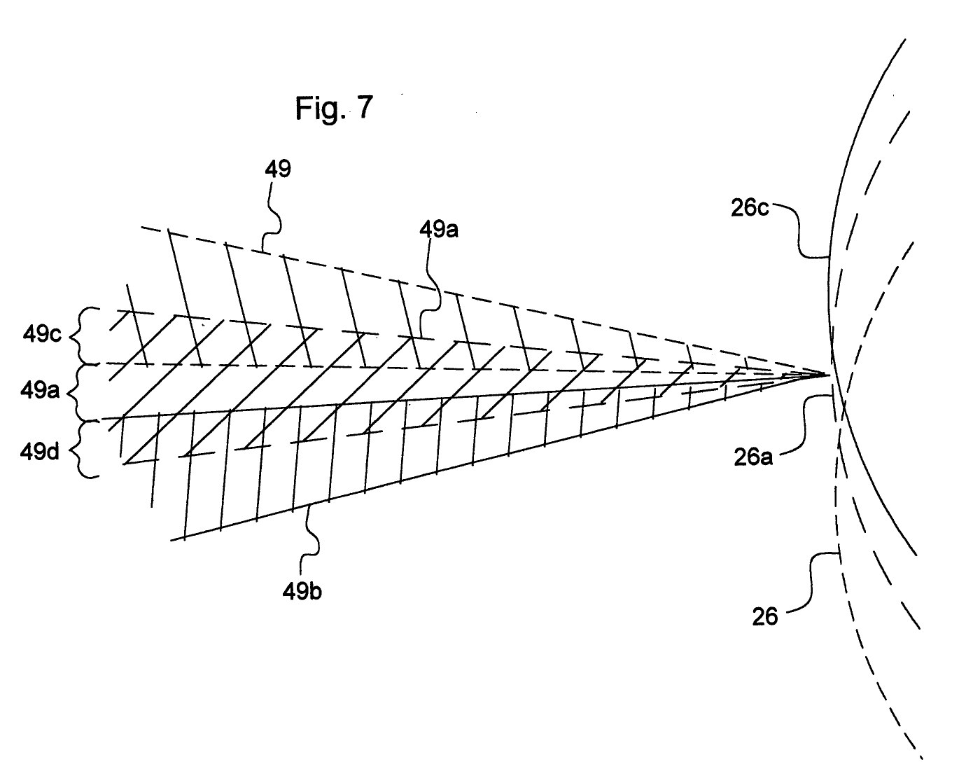

FIG. 7 depicts a top view of overlapping pixels producible by the present invention for increasing horizontal parallax resolution. The above 3D application discussion describes pixels that are engineered so as not to overlap such that the first pixel of the first intertwined sub-frame of the first frame will occupy a first one degree field of view and the first pixel of the second intertwined sub-frame of the first frame will occupy a second one degree field of view. Also, in the above discussion, the first one degree field of view abuts the second one degree field of view (except when the pixels are incident upon different lenticulars). FIG. 7 illustrates that the pixels can in fact over lap if desired. A first over lapping pixel 49 is reflected from a half step lenticular in first position 26, subsequently, a second over lapping pixel 49a is reflected from a half step lenticular in second position 26a, and subsequently, a third over lapping pixel 49b is reflected from a half step lenticular in third position 26a. In the 0.33 degree wide area where the 49 pixel over laps the 49a pixel, a first blended pixel 49c is created wherein a user's eye in the 49c blended area will perceive a blend of the 49 and 49a pixel. Similarly, n the 0.33 degree wide area where the 49a pixel over laps the 49b pixel, a second blended pixel 49d is created wherein a user's eye in the 49d blended area will perceive a blend of the 49a and 49b pixel. If the brightness of 49 is consistent across its entire field of view, and the brightness of the 49a is consistent across its entire field of view, and assuming 49 and 49a have equal brightness, then the brightness of 49c will be double that of 49. Having brighter blended pixels intermixed with and dimmer pure pixels may not be desirable. To ensure equal brightness of pure pixels compared to blended pixels, multiple projection of each pixel can be used. For example, first 49 can be projected from the left most edge to the left most edge of 49c, the 49 can then be projected from the left most edge of 49 to the right most edge of 49. This will provide twice the illumination in 49's pure zone compared to 49's blended zone.

### Second Embodiment

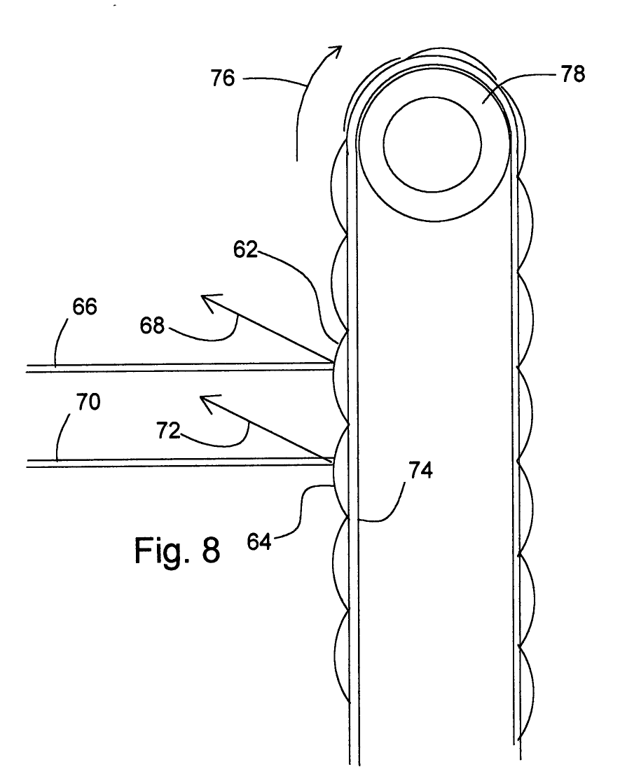

FIG. 8 depicts a top view of a different mode of actuating a lenticular array. A first reflective lenticular affixed to belt 62 and a second reflective lenticular affixed to belt 64 are among an array of similar vertical lenticulars. As a belt 74 to which they are affixed rotates 76. A first alternate pixel 66 is incident upon the 62 along with thirty other pixels (not shown) and reflected to user space as a first alternate reflected pixel 68. As an actuation roller 78 is advanced in 0.15 inch increments, the direction of the 68 pixel is swept across user space in twenty nine one degree increments such that users in a range of positions can see light from the pixel representative of different perspectives of a 3D image or representative of different video content entirely. Similarly a second alternate pixel 70 is incident upon the 64 and directed into user space as a second alternate reflected pixel 72 which is swept across user space representing different perspective or video content as 78 advances 74 incrementally.

### Third Embodiment

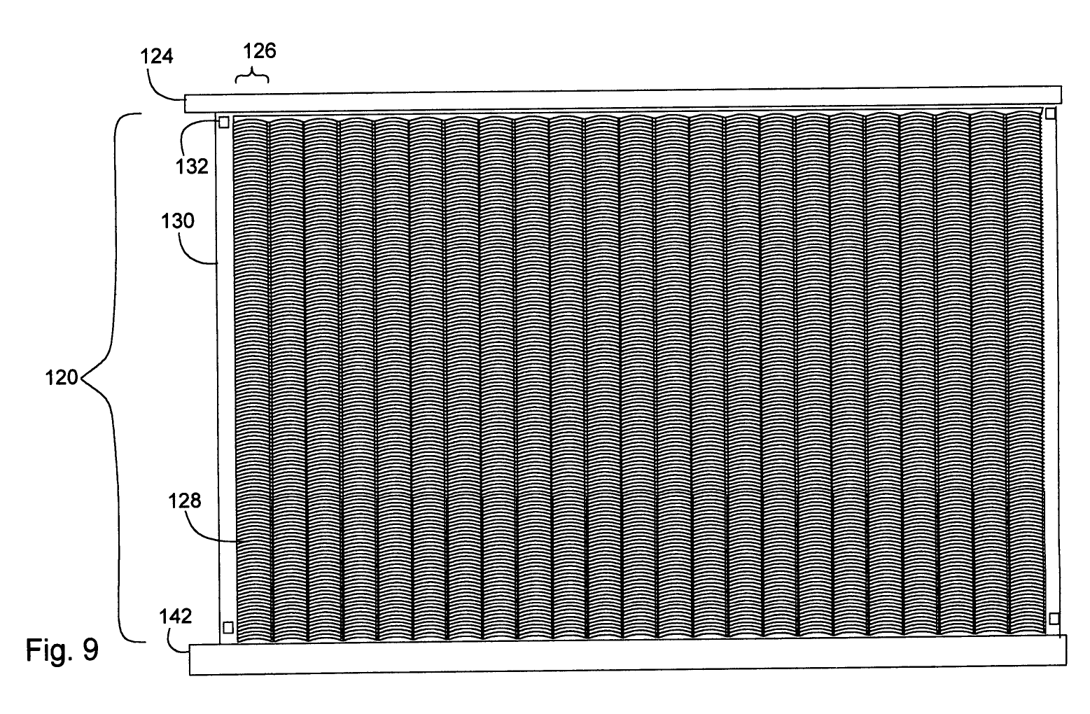

FIG. 9 depicts a front view of a transmissive actuate-able lenticular array. The above discussion describes the present invention in a reflective embodiment, the same approach is also practicable for transmissive embodiments. A transmissive actuate-able vertical lenticular array 120 is fabricated similarly to the reflective lenticular array previously described except that a convex vertical lenticular 126 is assembled from a flat transparent sheet with 1280 horizontal lenticulars cut into its surface similar to first convex horizontal lenticular 128 and then affixed to a transparent convex plastic form, the assembly then being affixed to a transparent rigid mounting board 130. A top transparent lenticular mounting assembly 124 and a bottom transparent lenticular mounting assembly 142 enable the system to be placed in front of any pixel generator for example a CRT, plasma display, or LCD display. The 120 is actuated in increments that can be smaller than, equal to, or greater that one pixel width depending upon the video content being presented to user space.

### Third Embodiment

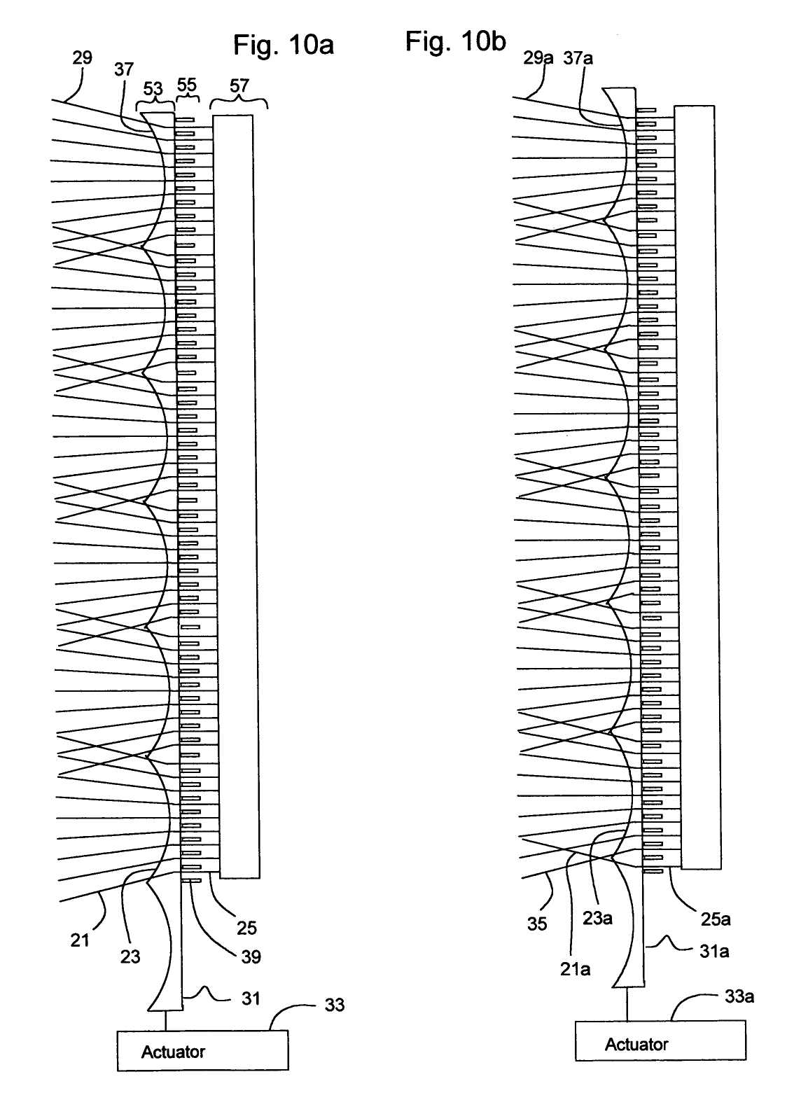

FIG. 10a is a top view of a 3D image recorder comprising an actuate-able vertical lenticular array in a first position. A first light from background 21 is incident upon a first convex vertical lenticular 23 which is part of a transparent actuate-able vertical lenticular array for recording 53 which comprises a multitude of vertical lenticulars each have no horizontal lenticulars as had been the case with the vertical lenticulars of FIG. 9. Also, the size of the 53 is small enough to be incorporated in a high speed video camera while the FIG. 9 vertical lenticular array is design to fit in front of a display. The 53 is fabricated by molding of lenticulars in a transparent sheet or by extrusion or by etching lenticular shapes into a rigid transparent substrate using a cutting tool such as is commonly practiced in the lenticular industry by companies such as Max Levy for example. The 23 causes the 21 to be bent such that it is not incident upon the light absorbing walls of a off axis filter 55 including first off axis absorbing wall 39. Portions of the light 21 light that is incident upon and bent by the 23 lenticular that fit within a one degree wide off axis limit constrained by the 55 including 39 are a first incident pixel light 25 incident upon a high speed video camera sensing CCD 57. The 57 includes a color filter technique well know in the art such as a Bayer filter so as to be able to sense the red, green, and blue, intensity of the 25 light Information describing the red, green, and blue intensity of the 21 is stored in a separate storage medium (not shown). Similarly, a second light from background 29 is incident upon a second convex vertical lenticular 37 which is part of the transparent actuate-able vertical lenticular array for recording 53. The 29 is bent by the 37, then filtered by the 55 to be a one degree wide color light from background also incident on the 57 which senses the red, green, and blue intensity. Information describing the red, green, and blue intensity of the 29 is stored in a separate storage medium (not shown). Note that the 21 light and the 29 light are in non-parallel planes until incident upon the 53 which bends them into parallel planes before they are incident upon the 57. High speed cameras having color filters, CCD's, electronics, and software to enable them to operate at frame rates exceeding 1800 frames per second and at resolution higher than 640×480 pixels and which can interface with an image storage medium are well known in the prior art. What is disclosed herein is a lens system and object light processing methodology for using such high speed cameras to record 3D video streams that can be played back as auto-stereoscopic video on the screens disclosed herein using the image light processing methodology disclosed herein. A camera lenticular actuator 33 has the vertical lenticular array in a first un-actuated position. In this position any light that is incident upon the third camera vertical lenticular 31 does not pass to the 57 sensor.

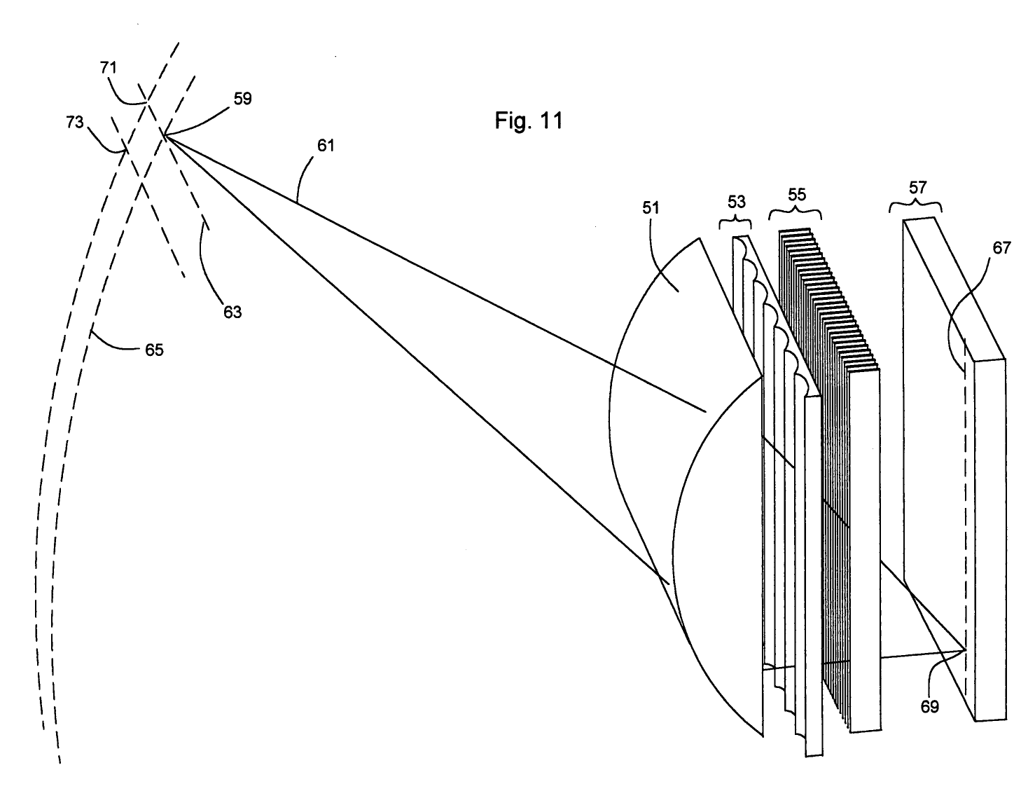

It is noteworthy that the architecture of FIGS. 10a, 10b, and 11 can be used to record video images that are directly playable on the vertical lenticular displays described herein. A very efficient structure to achieve this actually has twenty three vertical lenticulars each thirty pixels wide instead of the depicted seven vertical lenticulars each nine pixels wide. The 53 is actuated in 30 cycles of 1 pixel wide increments 60 times per second or at 1800 hertz.

FIG. 10b is a top view of the 3D image recorder of FIG. 10a but 11/800^{th} of a second subsequently. An advanced actuator 33a has moved the 53 one pixel width to the left such that some light which is now incident upon the actuated third camera vertical lenticular 31 a now passes through to the CCD. The first incident pixel light at subsequent time 25a is incident upon the same spot of the 57 as was 25 but the light comes from a plane from a different plane as can be seen by a first actuated camera incident light 21a. The second actuated incident light 35 is now the first light incident upon the second actuated camera lenticular 23a. The 35 is in a plane parallel to 21. In fact, light have a wide range of incident angles are incident upon the 53 at all times. For illustrative purposes, this light is not depicted because it is filtered out by the 55 light absorptive array. A high speed camera with CCD 27a senses and signals the new intensities of the frame in first actuated potion for 1/1800 of a second for 30 perspectives. A third incident camera light 29a is incident upon the left most actuated lenticular 37a it is a one degree wide portion of object space occupying a plane rotated one degree compared to the 29 on degree light FIG. 11 depicts components comprising a 3D actuate-able vertical lenticular array image recorder with a horizontal lenticular. The 53, 55, and 57 elements are present from FIGS. 10a and 10b and a horizontal camera lenticular 51 has been added. The 51 is a solid transparent convex lenticular that runs the length of the 53's width and has the height of the 53's height. The 51,53, 55, and 57 together comprise a high speed 3D camera system for recording 3D video that can be stored and played back on the vertical lenticular screens and systems described herein. The 53 is actuated in 30 cycles of 1 pixel wide increments 60 times per second or at 1800 hertz. The 51 creates focal points from light within object space at a distance which is a function of its curvature and refractive index. This distance can be changed in real time by moving 51 further away or closer to 53 alternately, to adjust focal distance, 57 can be moved further from or close to 55.

At the point in time depicted by FIG. 11, the 53 is actuated to a position such that a particular lenticular allows light emanating from with a first one degree wide plane 65 to pass through the 55 and be incident upon a first incident light on the CCD 67. The curvature of 51 causes a first light 61 light from a first object focal point 59 to be focused on the camera sensing elements as first focused pixel 69 where it is sensed and stored in memory by the high speed camera. A second object space focal point 71 will be passed to the high speed camera CCD through a different set of absorptive elements within the 55 than was the 69 as will a third focal point 73. The 71 lies at an imaginary intersection which corresponds to the focal distance of 51, is a plane that when bent by 53 will be parallel with the openings within 55 at a point on the curve corresponding to a pixel sensor position on the 57 to the left of the 67 line. In a subsequent point in time, the 71 light will be incident upon the 69 pixel as will other points along the 63 imaginary line. Thus The 51, 53, 55, and 57 system produces an image comprising light from vertically focused points in object space that are one degree wide horizontally.

### OPERATION OF THE INVENTION

Operation of the invention has been discussed under the above heading and is not repeated here to avoid redundancy.

Conclusion, Ramifications, and Scope

Thus the reader will see that the Processes and Apparatuses for Efficient Multiple Program and 3D Display of this invention provides a novel unanticipated, highly functional and reliable means for producing multiple functionalities and resolutions in a single display. In a single display, high resolution media can be displayed, media of lower resolution can be displayed, auto stereoscopic 3D media can be displayed, and multiple programs streams can be displayed all on the same display.

While the above description describes many specifications, these should not be construed as limitations on the scope of the invention, but rather as an exemplification of a preferred embodiment thereof. Many other variations are possible for example:

In the transmissive and reflective screen embodiments, the horizontal array of concave vertical lenticulars can be replaced by many other optical structures including horizontally arrayed convex lenticulars and horizontally and vertically arrayed round convex or concave optics. In the later cases, both horizontal and vertical steering actuation can be used to achieve both horizontal and vertical parallax. Similarly, in the transmissive optic application, an actuate-able vertical lenticular array can be used in conjunction with an actuate-able horizontal lenticular array where light passes through both the horizontal and vertical lenticulars for horizontal and vertical steering into user space. To optimize performance or reduce fabrication costs, the surfaces of the vertical and horizontal lenticulars can have steps in them or Fresnel structures to optimize performance or to flatten the actuate-able screen more.

The shapes of the optics can be engineered to achieve greater efficiencies. For example to optimize image fidelity, the vertical lenticulars on the left side of the screen can progressively have different curvatures that those in the middle of the screen or on the right side of the screen. Also, the curvature on an individual vertical lenticular can vary progressively from top to bottom.

The vertical lenticulars need not be positioned against a flat rigid support board where they from a straight line but could instead be positioned on a curved rigid support board to form a curve in the horizontal and/o vertical planes to optimize reflective characteristics of the system. In this case, the actuation would be along a curve instead of along a straight horizontal line as described herein.

Actuation of the vertical lenticular need not be in pixel size steps. For example, the exact same reflective screen described herein for producing auto-stereoscopic images with 640×480 resolution can be used to produce images with 1280×960 resolution and still use the 0.15 actuation steps. In this case, slices from each of thirty perspectives would be two pixels wide instead of one pixel wide. Many different combinations of horizontal and vertical lenticulars can be used to achieve high definition resolution. In both image recording and image displaying embodiments, actuation increments can be smaller than, equal to, or greater that one pixel width depending upon the system design.

Nearly any other pixel generation method can be substituted for the three chip DLP described herein.

The 3D content is described as being generated which is common for interacting with computer generated 3D environments. This process need not be done in real time but could entail the playing of previously recorded content for example. Fore example the #d recording system described herein can produce content that is playable on the 3D display.

The above description includes a relationship of adding one to the resolution divided by number of views to determine the number of lenticulars required (1+(640/30)=22.3 lenticulars required) (the description uses twenty three lenticulars to keep the lenticular shape constant). It is also possible to have nearly any number of vertical lenticulars. For example, the system can use only two vertical lenticulars in which case, the system must be actuated 640 times per frame this would require a pixel generator capable of 640×60=38,400 frames per second to generate motion video and also the physical actuation required is eight feet instead of the 4.5 inches proposed herein.

The pixels from the DLP projector is described as being convergent when incident upon the reflective lenticulars. The pixels can also be divergent or collimated when incident upon the reflective lenticulars in which case the curvature of the vertical lenticulars will be calculated accordingly. Also the reflected pixel widths are described as being one degree wide. Many other reflected pixel widths are also possible.

The reflective surface and shape of the vertical lenticular can be fabricated in alternate ways. For example, the fabrication can start with a reflective sheet which is then embossed with the horizontal lenticulars. Or a plastic sheet can be embossed with horizontal lenticulars to which the mirror surface is then deposited the sheet then being caused to conform to the vertical lenticular curvature.

Many other actuators can be used including electromagnetic and hydraulic for example.

The Actuator

Other elements may be actuated than are described. For example in the image displaying application, the pixel generator can be actuated instead of actuating the lenticulars. Similarly, in the image recording application, the image sensor can be actuated to achieve the same affect as described herein. A conical sensor array can be surrounded by a conical optical array wherein either the optical array or the sensor can be rotated to achieve a sensing or displaying effect.

Intervening optics can be added to the image display and image recording systems described herein. Also, it is anticipated that he 3D video camera application can utilize a horizontal lenticular with dimensions larger than those illustrated and larger relative to the CCD in which case, interviewing optics will be used to shape the image to be incident with fidelity upon the CCD.

The reflective and refractive optical structures can be replaced by other optical elements including refraction, reflection, and diffraction for example to produce similar results.

The prior related patent applications of the present applicant which are cross referenced herein also contain relevant information which is incorporated herein by reference but not repeated to avoid redundancy.

What is claimed:

1. A process for recording or playing three dimensional images comprising the steps of: providing an array of vertical lenticular optics,
providing an actuator,
providing at least one element selected from the group consisting of; a pixel emitter, and a pixel sensor,
wherein the said array of lenticulars is actuated perpendicular to the optical axis of said array of lenticulars in an automated iterative process by said actuator such that a first light incident upon a first portion of said array of lenticulars at a first instance in time represents a first off axis perspective and a second light incident upon the said first portion of said array of lenticulars at a second instance in time represents a second off axis perspective and wherein said first light and said second light is selected from the group consisting of: emitted from the same pixel emitter, and sensed by said pixel sensor.
